(19) United States
(12) Patent Application Publication
(10) Pub. No.: US 2020/0042946 A1
(43) Pub. Date: Feb. 6, 2020

(54) INFERRING SUCCESSFUL HIRES

(71) Applicant: Microsoft Technology Licensing, LLC, Redmond, WA (US)

(72) Inventors: Xiang Li, Santa Clara, CA (US); Yu Liu, Sunnyvale, CA (US); Yunjing Zhang, Sunnyvale, CA (US); Rishi Jobanputra, Atherton, CA (US)

(73) Assignee: Microsoft Technology Licensing, LLC, Redmond, WA (US)

(21) Appl. No.: 16/050,559

(22) Filed: Jul. 31, 2018

(51) Int. Cl. G06Q 10/10; G06N 5/04; G06N 99/00

(52) U.S. Cl. CPC G06Q 10/1053; G06N 99/005; G06N 5/04

(57) ABSTRACT

The disclosed embodiments provide a system for inferring successful hires in an online system. During operation, the system samples feedback from users of an online system to generate labels representing hiring outcomes from requests for proposal (RFPs) submitted in the online system. Next, the system inputs the labels with features representing interaction associated with the RFPs as training data for a machine learning model. The system then applies one or more rules derived from the machine learning model to additional features for an additional RFP to infer a hiring outcome for the additional RFP. Finally, the system stores the inferred hiring outcome in association with the additional RFP.

### BACKGROUND

### Field

The disclosed embodiments relate to inferences. More specifically, the disclosed embodiments relate to techniques for inferring successful hires.

### Related Art

Online networks may include nodes representing individuals and/or organizations, along with links between pairs of nodes that represent different types and/or levels of familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, run advertising and marketing campaigns, promote products and/or services, and/or search and apply for jobs.

In turn, online networks may facilitate activities related to business, sales, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for inferring successful hires in an online marketplace in accordance with the disclosed embodiments.

FIG. 3 shows a flowchart illustrating a process of inferring successful hires in an online marketplace in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The disclosed embodiments provide a method, apparatus, and system for assessing and/or improving the performance of an online marketplace, which can include an online system of software and/or hardware components that are connected to one another and/or external computer systems via one or more networks. More specifically, the disclosed embodiments provide a method, apparatus, and system for inferring successful hires in an online marketplace. Such inference may be performed in the absence of a payment platform and/or other mechanism for automatically confirming the completion of projects and/or delivery of goods or services within the online marketplace.

First, feedback from users of the online marketplace is sampled to generate labels representing hiring outcomes from requests for proposal (RFPs) submitted in the online marketplace. For example, the feedback may include closed projects, survey results, and/or other voluntarily provided user feedback from consumers and/or providers in the online marketplace. When the feedback includes a self-reported outcome that specifies hiring of a proposal submitted in response to an RFP, the RFP is labeled with a successful hire. When the feedback includes a self-reported outcome that specifies a lack of hired proposals submitted in response to the RFP, the RFP is labeled with an unsuccessful hire.

Next, the labels are inputted with features for the corresponding RFPs as training data for a machine learning model. For example, the labels and features may be used to train a decision tree and/or other type of classification model that predicts a successful or unsuccessful hire for an RFP based on activity and/or interaction associated with the RFP.

One or more rules are then derived from the machine learning model and used to infer successful hires from additional RFPs. For example, the rules may be used to predict successful hires from RFPs that lack user-reported hiring outcomes. Finally, the inferred successful hires are used to calculate and output a performance metric for the online marketplace. For example, the inferred successful hires may be combined with self-reported successful hires in the online marketplace and the number of RFPs submitted in the online marketplace to calculate a “hiring rate” or “transaction rate” for the online marketplace.

By inferring successful hires from RFPs in the absence of user feedback confirming the successful hires, the disclosed embodiments may improve the accuracy of performance metrics calculated from hiring outcomes in the online marketplace without requiring the use of survey results to identify the successful hires. In turn, the performance metrics may be used to recommend service providers in the online marketplace, assess the effectiveness of features and/or recommendations in the online marketplace, and/or otherwise promote or provide better services, service providers, and/or outcomes in the online marketplace. On the other hand, conventional techniques that rely on survey results to confirm hiring outcomes may have incomplete, inaccurate, and/or biased data, which may interfere with the analysis of the outcomes and/or the derivation of subsequent insight or decisions based on the outcomes.

Thus, the disclosed embodiments may improve the effectiveness or efficiency of measures for assessing or improving the growth or performance of the online marketplace, the value of the online marketplace to the users, the value provided to the online marketplace by the users, and/or user engagement with the online marketplace. The disclosed embodiments may further improve technologies related to the execution of online marketplaces through network-enabled devices and/or applications, as well as user engagement, user experiences, and interaction through the online marketplaces, network-enabled devices, and/or applications.

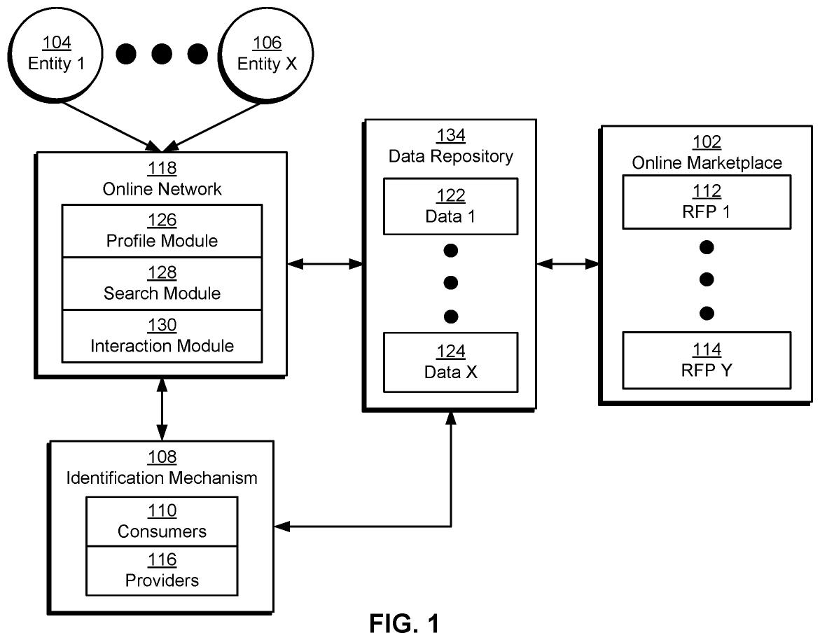

FIG. 1 shows a schematic of a system in accordance with the disclosed embodiments. In the system of FIG. 1, an online marketplace 102 may be associated with a user community such as an online network 118. In one or more embodiments, online network 118 includes an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

In turn, member profiles and/or activity with online network 118 may be used to improve interaction between consumers 110 and providers 116 and/or use of online marketplace 102 by consumers 110 and providers 116. Online marketplace 102 allows consumers 110 to generate RFPs (e.g., RFP 1 112, RFP y 114) for products or services by inputting requirements associated with the RFPs into a user interface, form, email, and/or other mechanism for digital communication or interaction. Online marketplace 102 may use the inputted requirements to select providers 116 that meet the requirements and transmit the RFPs to the selected providers 116. The selected providers 116 may respond to the RFPs with proposals, and consumers 110 that generated the RFPs may use the proposals to select providers 116 for the corresponding products or services.

As shown in FIG. 1, consumers 110 and/or providers 116 may be identified by an identification mechanism 108 using data from data repository 134 and/or online network 118. First, identification mechanism 108 may identify consumers 110 based on browsing, searching, and/or viewing activities of entities with online network 118. For example, identification mechanism 108 may determine that a member of online network 118 is interested in career services offered through online marketplace 102 based on the member's job-seeking activity (e.g., job searches, job applications, etc.) and/or profile-editing activity (e.g., profile edits, soliciting recommendations or endorsements, etc.) with online network 118. In another example, identification mechanism 108 may identify a member of online network 108 as a potential consumer when the member searches online marketplace 102 for products and/or services and/or submits an RFP through online marketplace 102.

Second, identification mechanism 108 may identify providers 116 as members of online network 118 who are highly skilled at services offered through online marketplace 102 and/or who have registered with online marketplace 102 as providers 116 of the services. For example, identification mechanism 108 may use endorsements, recommendations, and/or other social validation of skills listed in the member's profiles with online network 118 to identify members who are likely to be highly capable of providing services listed in online marketplace 102. In another example, identification mechanism 108 may identify a member of online network 118 as a provider in online marketplace 102 when the member views a page in online marketplace 102 for a service that strongly matches the member's skills and/or registers as a provider with online marketplace 102.

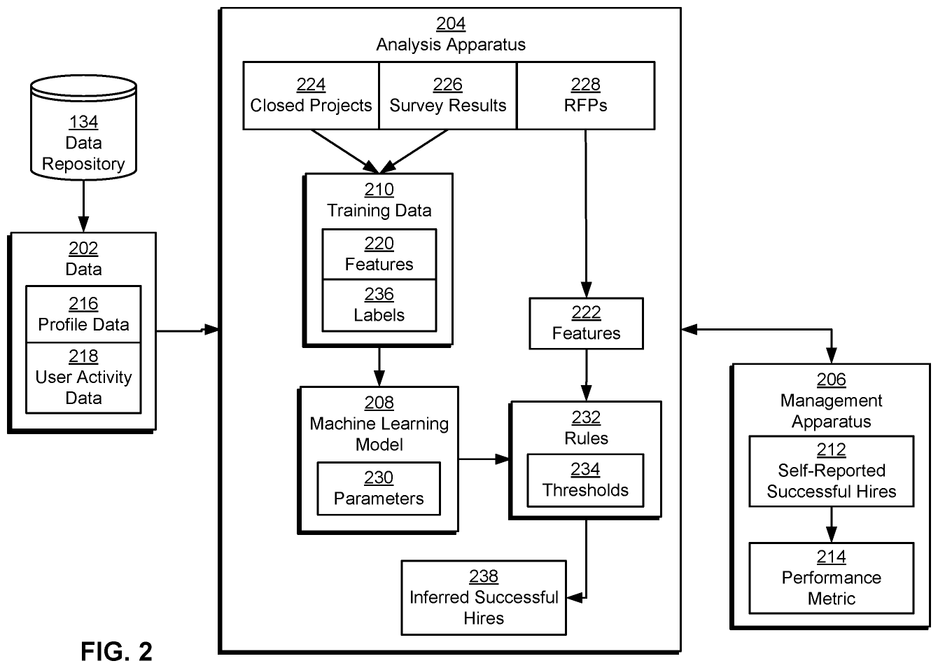

In one or more embodiments, online marketplace 102 uses data from online network 118 and/or data repository 134 to infer successful hires from RFPs submitted in online marketplace 102. As shown in FIG. 2, a system for inferring successful hires in an online marketplace (e.g., online marketplace 102 of FIG. 1) includes an analysis apparatus 204 and a management apparatus 206. Each of these components is described in further detail below.

As shown in FIG. 2, the system utilizes data 202 from data repository 134, which includes profile data 216 for members of an online network (e.g., online network 118 of FIG. 1), online marketplace, and/or other community of users, as well as user activity data 218 that tracks the members' activity within and/or outside the community. Profile data 216 includes data associated with member profiles in the community. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, awards or honors earned by the user, licenses or certifications attained by the user, patents or publications associated with the user, and/or other data related to the user's interaction with the community.

Attributes of the members may be matched to a number of member segments, with each member segment containing a group of members that share one or more common attributes. For example, member segments in the community may be defined to include members with the same industry, title, location, and/or language.

Connection information in profile data 216 may additionally be combined into a graph, with nodes in the graph representing entities (e.g., users, schools, companies, locations, etc.) in the community. Edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 includes records of user interactions with one another and/or content associated with the community. For example, user activity data 218 may be used to track impressions, clicks, likes, dislikes, shares, hides, comments, posts, updates, conversions, and/or other user interaction with content in the community. User activity data 218 may also, or instead, track other types of community activity, including connections, messages, job applications, job searches, recruiter searches for candidates, interaction between candidates 116 and recruiters, and/or interaction with groups or events. User activity data 218 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 may additionally include schedules, calendars, and/or upcoming availabilities of the users, which may be used to schedule meetings, interviews, and/or events for the users.

User activity data 218 may further track activities related to the online marketplace. The activities may include, but are not limited to, browsing or searching the online marketplace for providers, services, products, and/or projects; submitting, receiving, responding to, and/or accepting RFPs and/or proposals; viewing profiles of providers in the online marketplace; exchanging messages with providers and/or consumers; sending and/or receiving connection invitations with providers and/or consumers; and/or rating or reviewing providers and/or consumers. Like profile data 216, user activity data 218 may be used to create a graph, with nodes in the graph representing network members and/or content and edges between pairs of nodes indicating actions taken by members, such as creating or sharing articles or posts, sending messages, sending or accepting connection requests, browsing services in the online marketplace, sending and accepting RFPs, sending and accepting proposals, opening and closing projects, joining groups, and/or following other entities.

Profile data 216, user activity data 218, and/or other data 202 in data repository 134 may be standardized before the data is used by components of the system. For example, skills in profile data 216 may be organized into a hierarchical taxonomy that is stored in data repository 134 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In another example, locations in data repository 134 may include cities, metropolitan areas, states, countries, continents, and/or other standardized geographical regions. In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve other data that is represented by the time periods (e.g., starting a job in a given month or year, graduating from university within a five-year span, job listings posted within a two-week period, RFPs submitted in the last month, etc.). In a sixth example, data repository 134 includes standardized types and/or groupings of services and/or products offered by or through the online network and/or online marketplace.

As mentioned above, consumers in the online marketplace may obtain services by providers in the online marketplace by submitting RFPs 228 in the online marketplace. For example, a user may fill out an RFP for a design service, writing service, accounting service, marketing service, legal service, real estate service, software service, information technology (IT) service, business service, financial service, insurance service, photography service, career service, coaching service, and/or other type of service listed in the online marketplace.

Each RFP may be matched to a number of providers of the service requested in the RFP, such as providers with skills or qualifications that meet requirements outlined in the RFP. The providers may submit proposals in response to the RFP, which are reviewed by the consumer that submitted the RFP. The consumer may then communicate with the providers to clarify details of the proposals. The consumer may also, or instead, verify the providers' skills or qualifications by viewing the providers' profiles, recommendations, ratings, and/or reviews in the online marketplace and/or online network. Finally, the consumer may hire a provider to perform the service according to the terms of the corresponding proposal and/or details discussed with the provider after the proposal is received. Conversely, the consumer may fail to hire a provider for the RFP if none of the proposals and/or conversations result in an agreement that works for both the consumer and any providers that submitted proposals in response to the RFP.

After hiring or failing to hire a provider for the RFP, the consumer may provide feedback related to the outcome of the submitted RFP. For example, the consumer may voluntarily close the project represented by the RFP and provide a reason for closing the project as a successful or unsuccessful hire of a provider for the project through the online marketplace. In another example, the consumer may provide a rating and/or review of one or more proposals received in response to the RFP. Each rating and/or review may be accompanied by an indication as to whether the corresponding provider was hired or not hired for the RFP.

Conversely, a number of consumers may fail to provide feedback that confirms whether their RFPs led to successful or unsuccessful hires in the online marketplace. For example, the consumers may cease communication and/or activity associated with their RFPs without closing the corresponding projects and/or reporting hiring outcomes for the RFPs. As a result, the number and/or rate of successful hires in the online marketplace may be inaccurately assessed when only user feedback related to closed projects, ratings, and/or reviews is considered.

In one or more embodiments, analysis apparatus 204 uses profile data 216, user activity data 218, and/or other data 202 in data repository 134 to generate a set of inferred successful hires 238 from RFPs 228 submitted in the online marketplace. Inferred successful hires 238 may represent predictions of successful hires of providers for goods, products, and/or services requested in a set of RFPs 228 in the absence of feedback confirming the successful hires from consumers submitting the RFPs. As a result, inferred successful hires 238 may represent positive hiring outcomes that are separate from self-reported successful hires 212 obtained from voluntarily provided user feedback for a different set of RFPs.

To perform such inference, analysis apparatus 204 generates labels 236 representing hiring outcomes in the online marketplace from closed projects 224, survey results 226, and/or other historical user feedback related to RFPs submitted in the online marketplace. Labels 236 may indicate, for a given RFP, whether or not the consumer that submitted the RFP successfully hired a provider to perform the service requested in the RFP. For example, an RFP may be labeled with a successful hire when a provider is hired for the corresponding service in the online marketplace and with an unsuccessful hire when no providers are hired for the corresponding service in the online marketplace.

Closed projects 224 may represent RFPs that are no longer open or active in the online marketplace. When a consumer closes a project represented by an RFP, the user may no longer receive proposals, reminders, and/or other communications or updates related to the status of the corresponding project. In addition, the consumer may submit a request or command to close the project with a reason for closing the project (e.g., hiring a provider in the online marketplace, hiring a provider outside of the online marketplace, not being ready to hire yet, testing the online marketplace, and/or another reason). As a result, the RFP may be labeled with a successful hire when the consumer indicates that the project was closed because a provider was hired within the online marketplace. Conversely, the RFP may be labeled with an unsuccessful hire when the consumer indicates that the project was closed for any other reason.

Survey results 226 may include the consumer's feedback for proposals received in response to the consumer's RFP. For example, the online marketplace may allow each consumer to provide a rating, review, and/or other survey results 226 for each proposal received from a provider in response to an RFP submitted by the consumer. The consumer may specify, in survey results 226, whether or not the consumer hired the provider or proposal being reviewed. In turn, the RFP may be labeled with a successful hire if the consumer submits any survey results 226 specifying that a provider or proposal was hired for the service requested in the RFP. On the other hand, the RFP may be labeled with an unsuccessful hire if no survey results 226 submitted by the consumer specify hiring of a provider or proposal for the service.

Analysis apparatus 204 also obtains and/or generates features 220 associated with RFPs for which labels 236 were generated. For example, analysis apparatus 204 may obtain features from data repository 134 and/or another data store and/or calculate features from data in the data store.

In one or more embodiments, features 220 relate to activity or interaction associated with the corresponding RFPs and labels 236, such as RFPs and labels 236 associated with closed projects 224 and/or survey results 226. First, features 220 for a given RFP may characterize interaction between the consumer that submitted the RFP and providers that responded to the RFP with proposals. Such features 220 may reflect the user's type or level of interest, engagement, and/or motivation in finding or hiring a provider for the requested service.

In particular, features 220 may include the maximum number of messages between the consumer and any provider that responded to the consumer's RFP. For example, a consumer that interacts with three out of five providers that responded to the consumer's RFP and has conversations that are two, three, and five messages long, respectively, with the three providers may have a maximum number of five messages for the RFP.

Features 220 may also, or instead, include the median number of messages between the consumer and all providers that responded to the RFP. Continuing with the previous example, the consumer with conversation lengths of two, three, and five messages with three out of five providers may have a median number of messages of 2, which is obtained as the median number from the consumer's message lengths of 0, 0, 2, 3 and 5 with all five providers.

Features 220 may also, or instead, include a contribution rate of the consumer to messages between the consumer and one or more providers that responded to the consumer's RFP. The contribution rate may be calculated as the proportion of all messages between the consumer and provider(s) that are from the consumer. For example, a consumer that sends five out of 20 messages to all providers that responded to the consumer's RFP may have a contribution rate of 5/20, or 0.25. In another example, a consumer may have a separate contribution rate for each provider with whom the consumer corresponds.

Second, features 220 may indicate activity associated with verifying the identities of the providers in the online marketplace. For example, features 220 may include views of the providers' profiles, recommendations, reviews, endorsements, ratings, and/or other attributes provided by the online marketplace and/or online network that can be used to evaluate the providers' skills and/or qualifications in performing the requested services.

Analysis apparatus 204 uses features 220 and labels 236 for RFPs associated with closed projects 224, survey results 226, and/or other user feedback as training data 210 for a machine learning model 208. For example, analysis apparatus 204 may use a training technique and/or one or more hyperparameters to update parameters 230 (e.g., coefficients, weights, etc.) of machine learning model 208 based on features 220 and labels 236. In turn, machine learning model 208 may be trained to predict labels 236 based on the corresponding features 220. After parameters 230 are created and/or updated, analysis apparatus 204 may store parameters 230 in data repository 134 and/or another data store for subsequent retrieval and use.

Those skilled in the art will appreciate that training data 210 may include a relatively small set of features 220 and labels 236 from user-reported outcomes in closed projects 224, survey results 226, and/or other sources of voluntary user feedback in the online marketplace. To increase the size of the data set used to train machine learning model 208, analysis apparatus 204 may sample the user feedback to produce a corresponding set of features 220 and/or labels 236 for inclusion in training data 210. For example, analysis apparatus 204 may generate features 220 and labels 236 using a bootstrapping technique that randomly samples closed projects 224 and/or survey results 226 with replacement. As a result, analysis apparatus 204 may generate a set of training data 210 that is larger than the number of closed projects 224 and/or survey results 226 without deviating from the distribution of features 220 and/or hiring outcomes in closed projects 224 and/or survey results 226.

After parameters 230 of machine learning model 208 are updated based on training data 210, analysis apparatus 204 derives one or more rules 232 from machine learning model 208. For example, machine learning model 208 may be a decision tree that includes thresholds 234 and/or conditions that are applied to different features 220. As a result, rules 232 may include a subset of thresholds 234 and/or conditions that have the highest values of accuracy, purity, precision, and/or recall in the decision tree. Rules 232 may also, or instead, include thresholds 234 and/or conditions that can be generalized to most or all RFPs received through the online marketplace and/or RPFs for specific goods, products, and/or services in the online marketplace.

Continuing with the above example, rules 232 may include thresholds and/or ranges of values from the decision tree that relate to the maximum and/or median number of messages between a consumer that submitted an RFP and one or more providers that responded to the RFP with proposals. Each rule may be used to identify a “segment” of consumers that successfully hire providers in the online marketplace after engaging in a certain type of interaction with the providers.

A first rule may include a minimum threshold of less than or equal to 4 for the maximum number of messages between a consumer and a set of providers for the consumer's RFP and a maximum threshold of less than 2 for the median number of messages between the consumer and the providers. The first rule may identify consumers that target and eventually hire specific providers that match the consumers' requirements and/or preferences.

A second rule may include a minimum threshold of at least 18 for the maximum number of messages between a consumer and a set of providers for the consumer's RFP. The second rule may identify consumers that are highly motivated and interested in a specific proposal that fulfills the consumers' needs.

A third rule may include a range of between 4 and 18 for the maximum number of messages between a consumer and a set of providers for the consumer's RFP and a range of between 2 and 9 for the median number of messages between the consumer and the providers. The third rule may identify consumers that explore options by proactively replying to multiple proposals and that eventually settle on providers that best meet the consumers' needs or preferences.

Analysis apparatus 204 applies rules 232 to additional features 222 of RFPs 228 that were not used to train machine learning model 208 to identify a set of inferred successful hires 238 from RFPs 228. For example, analysis apparatus 204 may use rules 232 to identify corresponding subsets of RFPs 228 with features 222 that indicate or reflect successful hires of providers for the corresponding services in the online marketplace. Such inference may be performed after messaging and/or other activity associated with the corresponding RFPs has lapsed for a certain period (e.g., a number of days, a week, a month, etc.) and/or based on other criteria. In addition, inferred successful hires 238 may be determined from RFPs 228 for which user feedback is not received, unlike self-reported successful hires 212 that are obtained from user feedback (e.g., closed projects and/or survey results) confirming positive hiring outcomes for a different set of RFPs.

In turn, management apparatus 206 combines inferred successful hires 238 with self-reported successful hires 212 to calculate a performance metric 214 for the online marketplace. For example, management apparatus 206 may obtain performance metric 214 as a “hiring rate” or “transaction rate” in the online marketplace, which represents the proportion of submitted RFPs that result in successful hires within the online marketplace. To calculate the “hiring rate” or “transaction rate,” the sum of the number of inferred successful hires 238 and the number of self-reported successful hires 212 may be divided by the total number of RFPs from which inferred successful hires 238 and self-reported successful hires 212 were identified.

In addition, performance metric 214 may be calculated for different subsets of RFPs 228, consumers, and/or providers in the online marketplace. For example, a different hiring or transaction rate may be calculated for each type of service requested in the online marketplace and/or consumers or providers from a given user or market segment.

Management apparatus 206 also outputs performance metric 214 to facilitate evaluation and/or decision-making related to the performance or value of the online marketplace. For example, management apparatus 206 may display a graph, chart, and/or visualization of performance metric 214 over time to facilitate evaluation of the effect of testing, initiatives, and/or decisions on the growth, success, and/or value of the online marketplace. In another example, management apparatus 206 may display different values of performance metric 214 for different market segments and/or services in the online market place to allow the growth, popularity, and/or performance of the market segments and/or services to be assessed. In a third example, management apparatus 206 may display different values of performance metric 214 for multiple versions of the online marketplace and/or multiple products to enable comparison of performance across the versions and/or products.

By identifying inferred successful hires 238 from RFPs 228 in the absence of user feedback confirming the successful hires, the system of FIG. 2 may improve the accuracy of other performance metrics (e.g., performance metric 214) calculated from hiring and/or other outcomes in the online marketplace. In turn, the system may improve the effectiveness or efficiency of measures for assessing or improving the growth or performance of the online marketplace, the value of the online network and/or online marketplace to the users, the value provided to the online network and/or online marketplace by the users, and/or user engagement with the online network and/or online marketplace. Consequently, the system may improve technologies related to use of online networks and/or online marketplaces through network-enabled devices and/or applications, as well as user engagement, user experiences, and interaction through the online networks, online marketplaces, network-enabled devices, and/or applications.

Those skilled in the art will appreciate that the system of FIG. 2 may be implemented in a variety of ways. First, analysis apparatus 204, management apparatus 206, and/or data repository 134 may be provided by a single physical machine, multiple computer systems, one or more virtual machines, a grid, a cluster, one or more databases, one or more filesystems, and/or a cloud computing system. Analysis apparatus 204 and management apparatus 206 may additionally be implemented together and/or separately by one or more hardware and/or software components and/or layers.

Second, a number of techniques may be used to obtain rules 232, thresholds 234, inferred successful hires 238, and/or performance metric 214. For example, the functionality of machine learning model 208 may be provided by a regression model, artificial neural network, support vector machine, decision tree, random forest, gradient boosted tree, naïve Bayes classifier, Bayesian network, clustering technique, collaborative filtering technique, deep learning model, hierarchical model, and/or ensemble model. The retraining or execution of machine learning model 208 may also be performed on an offline, online, and/or on-demand basis to accommodate requirements or limitations associated with the processing, performance, or scalability of the system and/or the availability of features 220 and/or labels 236 used to train the machine learning model. Multiple versions of machine learning model 208 may further be adapted to different subsets of consumers, providers, and/or services, or the same machine learning model 208 may be used to generate rules 232 for identifying inferred successful hires 238 from all consumers, providers, and/or services in the online marketplace.

Third, the system of FIG. 2 may be adapted to infer hiring and/or other types of outcomes for other platforms. For example, the system may be used to infer positive, negative, and/or other outcomes with a recruiting or job-seeking tool (e.g., successful or unsuccessful hiring for a job listed using the tool), marketing or advertising campaign, sales tool, and/or other type of platform for procuring, generating, or providing goods, products, services, and/or conversions.

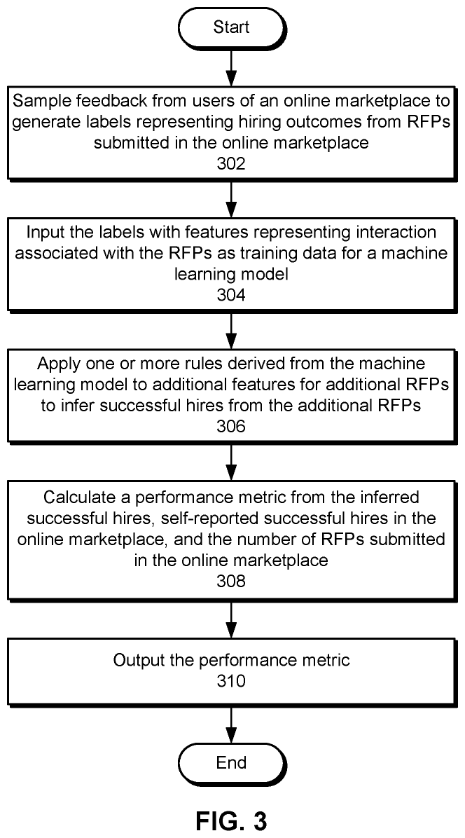

FIG. 3 shows a flowchart illustrating a process of inferring successful hires in an online marketplace in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, feedback from users of an online marketplace is sampled to generate labels representing hiring outcomes from RFPs submitted in the online marketplace (operation 302). For example, a bootstrapping technique may be used to sample, with replacement, a relatively small set of survey results, closed projects, and/or other types of user feedback from consumers that submitted the RFPs and/or providers that submitted proposals in response to the RFPs. In turn, the bootstrapping and/or sampling technique may generate a larger set of labels that adheres to the distribution of hiring outcomes in the user feedback. During sampling of the user feedback, an RFP may be labeled with a successful hire when a self-reported outcome indicates hiring of a proposal submitted in response to the RFP. Conversely, an RFP may be labeled with an unsuccessful hire when a self-reported outcome specifies a lack of hired proposals submitted in response to the RFP.

Next, the labels are inputted with features representing interaction associated with the RFPs as training data for a machine learning model (operation 304). For example, the features may include a maximum number of messages between a consumer that submitted an RFP and any provider that responded to the RFP, a median number of messages between the consumer and all providers that responded to the RFP, and/or a contribution rate of the consumer to messages between the consumer and one or more providers that responded to the RFP. The features may also, or instead, include a provider-verification feature indicating activity associated with verifying an identity of a provider in the online marketplace. The activity may include, but is not limited to, a view of a profile for the provider, a view of a recommendation of the provider, and/or a view of a rating for the provider.

One or more rules derived from the machine learning model are then applied to additional features for additional RFPs to infer successful hires from the additional RFPs (operation 306). For example, the rules may be generated from a subset of thresholds, conditions, and/or parameters with the highest purity, accuracy, precision, and/or recall from a tree-based model that identifies one or more sets of inferred hires from interaction metrics between consumers and providers associated with the corresponding RFPs. The rules may include, but are not limited to, minimum values, maximum values, thresholds, and/or ranges of values for the maximum and/or median number of messages between a consumer and providers that responds to the consumer's RFP. When a condition specified in a rule is met by a corresponding set of features, a successful hire may be identified for the RFP represented by the features.

In another example, the rules may include statistically significant regression coefficients from a logistic regression model that classifies an RFP as a successful or unsuccessful hire. The regression coefficients may be combined with the corresponding features to obtain output that represents predictions of successful or unsuccessful hires for a set of RFPs.

A performance metric is calculated from the inferred successful hires, self-reported successful hires in the online marketplace, and the number of RFPs submitted in the online marketplace (operation 308). For example, the performance metric may include a “hiring rate” that represents the proportion of RFPs that result in successful hires in the online marketplace. The hiring rate may be calculated by summing the inferred successful hires and self-reported successful hires from a set of RFPs (e.g., RFPs received over a given period and/or for a certain market segment) and dividing the sum by the total number of RFPs in the set.

Finally, the performance metric is outputted (operation 310). For example, the performance metric may be included in a chart, graph, and/or visualization that allows the performance metric to be tracked over time and/or compared to other performance metrics for other products or features. In another example, the performance metric may be stored and/or outputted in a table, spreadsheet, database, file, report, alert, and/or other type of data format.

Inferred hiring outcomes from the machine learning model may also, or instead, be stored in association with the corresponding RFPs. In turn, the hiring outcomes may be used to select service providers as matches for subsequent RFPs, generate recommendations for consumers seeking services provided by the service providers, and/or generate other output for improving use of the online marketplace.

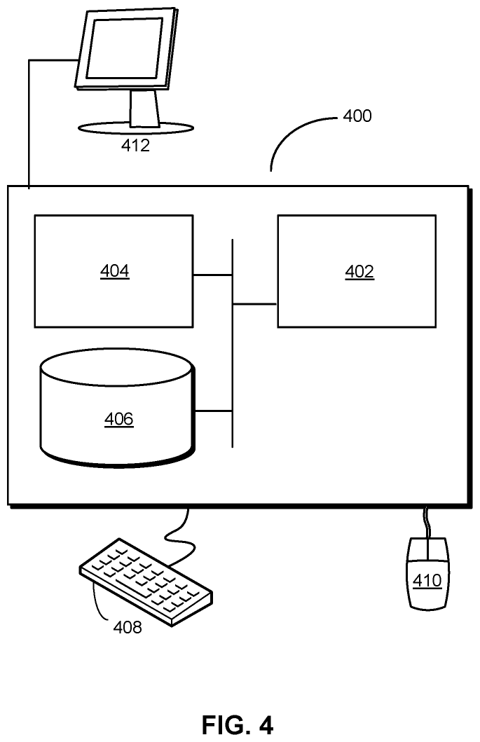

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for inferring successful hires in an online system such as an online marketplace. The system includes an analysis apparatus and a management apparatus, one or more of which may alternatively be termed or implemented as a module, mechanism, or other type of system component. The analysis apparatus samples feedback from users of an online marketplace to generate labels representing hiring outcomes from requests for proposal (RFPs) submitted in the online marketplace. Next, the analysis apparatus inputs the labels with features representing interaction associated with the RFPs as training data for a machine learning model. The analysis apparatus then applies one or more rules derived from the machine learning model to additional features for additional RFPs to infer successful hires from the additional RFPs. Finally, the management apparatus outputs, based on the additional RFPs and the additional successful hires, a performance metric for the online marketplace. The management apparatus may also, or instead, store inferred hiring outcomes from the machine learning model in association with the corresponding RFPs. In turn, the inferred hiring outcomes may be used to recommend service providers or services in the online marketplace, assess the effectiveness of features and/or recommendations in the online marketplace, and/or otherwise promote or provide better services, service providers, and/or outcomes in the online marketplace.

In addition, one or more components of computer system 400 may be remotely located and connected to the other components over a network. Portions of the present embodiments (e.g., analysis apparatus, management apparatus, data repository, online network, online marketplace, etc.) may also be located on different nodes of a distributed system that implements the embodiments. For example, the present embodiments may be implemented using a cloud computing system that infers successful hires associated with remote users of an online marketplace.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
sampling, by one or more computer systems, feedback from users of an online system to generate labels representing hiring outcomes from requests for proposal (RFPs) submitted in the online system;
inputting, by the one or more computer systems, the labels with features representing interaction associated with the RFPs as training data for a machine learning model;
applying, by the one or more computer systems, one or more rules derived from the machine learning model to additional features for an additional RFP to infer a hiring outcome for the additional RFP; and
storing, by the one or more computer systems, the inferred hiring outcome in association with the additional RFP.

2. The method of claim 1, wherein sampling the user feedback to generate the labels representing the hiring outcomes from the RFPs submitted in the online system comprises:
labeling an RFP with a successful hire when a self-reported outcome comprises a hiring of a proposal submitted in response to the RFP.

3. The method of claim 1, wherein sampling the user feedback to generate the labels representing the hiring outcomes from the RFPs submitted in the online system comprises:
labeling an RFP with an unsuccessful hire when a self-reported outcome comprises a lack of hired proposals submitted in response to the RFP.

4. The method of claim 1, wherein the features comprise a maximum number of messages between a consumer that submitted an RFP and any provider that responded to the RFP.

5. The method of claim 4, wherein the one or more rules comprise a threshold for the maximum number of messages.

6. The method of claim 1, wherein the features comprise a median number of messages between a consumer that submitted an RFP and all providers that responded to the RFP.

7. The method of claim 6, wherein the one or more rules comprise a range of values for the median number of messages.

8. The method of claim 1, wherein the features comprise a contribution rate of a consumer to messages between the consumer and one or more providers that responded to the RFP.

9. The method of claim 1, wherein the features comprise a provider-verification feature indicating activity associated with verifying an identity of a provider in the online system.

10. The method of claim 9, wherein the activity is at least one of:
a view of a profile for the provider;
a view of a recommendation of the provider; and
a view of a rating for the provider.

11. The method of claim 1, further comprising:
calculating the performance metric from the inferred successful hires, self-reported successful hires in the online system, and a number of RFPs submitted in the online system.

12. The method of claim 1, wherein applying the one or more rules derived from the machine learning model to the additional features for the additional RFPs comprises:
creating the one or more rules from a subset of parameters for the machine learning model.

13. A system, comprising:
one or more processors; and
memory storing instructions that, when executed by the one or more processors, cause the system to:
sample feedback from users of an online system to generate labels representing hiring outcomes from requests for proposal (RFPs) submitted in the online system;
input the labels with features representing interaction associated with the RFPs as training data for a machine learning model;
apply one or more rules derived from the machine learning model to additional features for additional RFPs to infer successful hires from the additional RFPs; and
output, based on the additional RFPs and the additional successful hires, a performance metric for the online system.

14. The system of claim 13, wherein sampling the user feedback to generate the labels representing the hiring outcomes from the RFPs submitted in the online system comprises:
labeling a first RFP with a successful hire when a first self-reported outcome comprises a hiring of a proposal submitted in response to the first RFP; and
labeling a second RFP with an unsuccessful hire when a second self-reported outcome comprises a lack of hired proposals submitted in response to the second RFP.

15. The system of claim 13, wherein sampling the user feedback to generate the labels representing the hiring outcomes from the RFPs submitted in the online system comprises:
applying a bootstrapping technique that samples the self-reported outcomes with replacement to generate the labels from the RFPs.

16. The system of claim 13, wherein the features comprise:
a maximum number of messages between a consumer that submitted an RFP and any provider that responded to the RFP; and
a median number of messages between a consumer that submitted an RFP and all providers that responded to the RFP.

17. The system of claim 16, wherein the one or more rules comprise at least one of:
a threshold for the maximum number of messages; and
a range of values for the median number of messages.

18. The system of claim 13, wherein the features comprise a provider-verification feature indicating activity associated with verifying an identity of a provider in the online system.

19. The system of claim 13, wherein applying the one or more rules derived from the machine learning model to the additional features for the additional RFPs comprises:
creating the one or more rules from a subset of parameters for the machine learning model.

20. A non-transitory computer-readable storage medium storing instructions that when executed by a computer cause the computer to perform a method, the method comprising:
sampling feedback from users of an online system to generate labels representing hiring outcomes from requests for proposal (RFPs) submitted in the online system;
inputting the labels with features representing interaction associated with the RFPs as training data for a machine learning model;
applying one or more rules derived from the machine learning model to additional features for an additional RFP to infer a hiring outcome for the additional RFP; and
storing, by the one or more computer systems, the inferred hiring outcome in association with the additional RFP.
